(19) United States
(12) Patent Application Publication
(10) Pub. No.: US 2026/0367234 A1
(43) Pub. Date: Nov. 19, 2026

(54) METHOD AND DEVICE FOR TRANSMITTING AND RECEIVING SIGNAL IN WIRELESS COMMUNICATION SYSTEM

(71) Applicant: LG ELECTRONICS INC., Seoul (KR)

(72) Inventors: Jihwan JANG, Seoul (KR); Jaehoon CHUNG, Seoul (KR); Jaeky OH, Seoul (KR)

(73) Assignee: LG ELECTRONICS INC., Seoul (KR)

(21) Appl. No.: 19/135,735

(22) PCT Filed: Dec. 5, 2022
(86) PCT No.: PCT/KR2022/019594

§ 371 Date: Jun. 4, 2025

(51) Int. Cl. G01S 13/00; G01S 7/00; H04W 56/00; H04W 72/044

(52) U.S. Cl. CPC G01S 13/003; G01S 7/006; H04W 56/0015; H04W 72/044

(57) ABSTRACT

The present disclosure may provide an operation method of a terminal in a wireless communication system. The operation method of the terminal may comprise the steps of: receiving a synchronization signal block (SSB) from a first base station; identifying a master information block (MIB) on the basis of the SSB; identifying a system information block (SIB) on the basis of the MIB; receiving resource allocation information included in the SIB; sensing a first object through some of resources allocated via the resource allocation information, and when the terminal is unable to sense the first object on the basis of a non-line-of-sight (NLOS) environment, requesting distributed sensing from the first base station; and receiving distributed sensing information from the first base station and completing sensing of the first object.

### CROSS-REFERENCE TO RELATED APPLICATION(S)

This application is the National Stage filing under 35 U.S.C. 371 of International Application No. PCT/KR2022/019594, filed on Dec. 5, 2022, the contents of which are all incorporated by reference herein in its entirety.

### TECHNICAL FIELD

The following description relates to a wireless communication system, and more particularly, to a method and device for sensing a signal in a wireless communication system.

Specifically, a method and device for sensing a signal using joint communication and sensing (JCAS) technology may be provided.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure relates to a device and method for sensing a signal in a wireless communication system.

The present disclosure may provide a device and method for sensing a signal using joint communication and sensing (JCAS) technology in a wireless communication system.

The present disclosure may provide a device and method for performing distributed sensing using a JCAS signal in a wireless communication system.

The technical objectives of the present disclosure are not limited to the items described above, and other technical objectives not explicitly described may be considered by a person skilled in the art from the embodiments described hereinafter.

According to an embodiment of the present disclosure, A method for operating a user equipment (UE) in a wireless communication system, the method may include: receiving, from a first base station, a synchronization signal block (SSB); identifying a master information block (MIB) based on the SSB; identifying a system information block (SIB) based on the MIB; receiving resource allocation information included in the SIB; sensing a first object through a portion of resources allocated through the resource allocation information, and if the UE cannot sense the first object based on a non-line-of-sight (NLOS) environment, requesting, to the first base station, distributed sensing; and completing, by receiving distributed sensing information from the first base station, the sensing of the first object based on the received distributed sensing information.

According to an embodiment of the present disclosure, A method for operating a first base station in a wireless communication system, the method may include: transmitting, to a UE, a synchronization signal block (SSB); receiving a distributed sensing request from the UE if the UE performs sensing of a first object using a portion of resources allocated through resource allocation information based on the SSB and cannot sense the first object based on a non-line-of-sight (NLOS) environment; and transmitting, to the UE, distributed sensing information.

According to an embodiment of the present disclosure, a UE in a wireless communication system, the UE may include: a transceiver; and a processor coupled with the transceiver, wherein the processor may be configured to perform operations including: receiving, from a first base station, a synchronization signal block (SSB); identifying a master information block (MIB) based on the SSB; identifying a system information block (SIB) based on the MIB; receiving resource allocation information included in the SIB; sensing a first object through a portion of resources allocated through the resource allocation information, and if the UE cannot sense the first object based on a non-line-of-sight (NLOS) environment, requesting, to the first base station, distributed sensing; and completing, by receiving distributed sensing information from the first base station, the sensing of the first object based on the received distributed sensing information.

According to an embodiment of the present disclosure, a base station in a wireless communication system, the base station may include: a transceiver; and a processor coupled with the transceiver, wherein the processor may be configured to perform operations including: transmitting, to a UE, a synchronization signal block (SSB); receiving a distributed sensing request from the UE if the UE performs sensing of a first object using a portion of resources allocated through resource allocation information based on the SSB and cannot sense the first object based on a non-line-of-sight (NLOS) environment; and transmitting, to the UE, distributed sensing information.

According to an embodiment of the present disclosure, a device including at least one memory and at least one processor operably connected to the at least one memory, wherein the at least one processor, by the device, may be configured to perform operations including: receiving, from a first base station, a synchronization signal block (SSB); identifying a master information block (MIB) based on the SSB; identifying a system information block (SIB) based on the MIB; receiving resource allocation information included in the SIB; sensing a first object through a portion of resources allocated through the resource allocation information, and if the UE cannot sense the first object based on a non-line-of-sight (NLOS) environment, requesting, to the first base station, distributed sensing; and completing, by receiving distributed sensing information from the first base station, the sensing of the first object based on the received distributed sensing information.

According to an embodiment of the present disclosure, a non-transitory computer-readable storage medium storing at least one instruction, including at least one instruction executable by a processor, wherein the at least one instruction may be configured to perform operations including: receiving, from a first base station, a synchronization signal block (SSB); identifying a master information block (MIB) based on the SSB; identifying a system information block (SIB) based on the MIB; receiving resource allocation information included in the SIB; sensing a first object through a portion of resources allocated through the resource allocation information, and if the UE cannot sense the first object based on a non-line-of-sight (NLOS) environment, requesting, to the first base station, distributed sensing; and completing, by receiving distributed sensing information from the first base station, the sensing of the first object based on the received distributed sensing information.

The following embodiments may be commonly applied.

According to an embodiment of the present disclosure, for example, the requesting of the distributed sensing is transmitted to a second base station by a central unit, and for example, the distributed sensing information is a sensing result performed by the second base station in a line-of-sight (LOS) environment.

According to an embodiment of the present disclosure, for example, the sensing performed in the LOS environment is sensing for the first object, which is in an NLOS environment for the UE and in a LOS environment for the second base station.

According to an embodiment of the present disclosure, for example, the distributed sensing is not performed if the UE receives an echo signal, and is performed if the UE does not receive the echo signal, and for example, the echo signal is a signal reflected by an object to be sensed from a JCAS signal transmitted by the UE.

According to an embodiment of the present disclosure, for example, the UE has information related to a surrounding environment excluding the object to be sensed.

According to an embodiment of the present disclosure, for example, the second base station is determined by the central unit by identifying whether multiple base stations, in order of proximity to the UE, are in a LOS environment for the first object.

According to an embodiment of the present disclosure, for example, whether to be in the LOS environment is determined based on whether an echo signal, reflected from the first object by a joint communication and sensing (JCAS) signal transmitted from at least one of the multiple base stations based on a request from the UE, is received by the at least one of the multiple base stations.

According to an embodiment of the present disclosure, for example, at least one of the UE, the first base station, and a second base station includes a JCAS module capable of simultaneously implementing radar technology and communication technology.

According to an embodiment of the present disclosure, for example, the distributed sensing is performed by using a JCAS signal.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

The embodiments based on the present disclosure may have the following effects.

The present disclosure may provide an advantage of improved performance in sensing an object obstructed by obstacles in a wireless communication system.

The present disclosure may provide an advantage of improved sensing performance by proposing a distributed sensing method using joint communication and sensing (JCAS) technology in a wireless communication system.

The technical objectives of the present disclosure are not limited to the items described above, and other technical objectives not explicitly described may be considered by a person skilled in the art from the embodiments described hereinafter.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

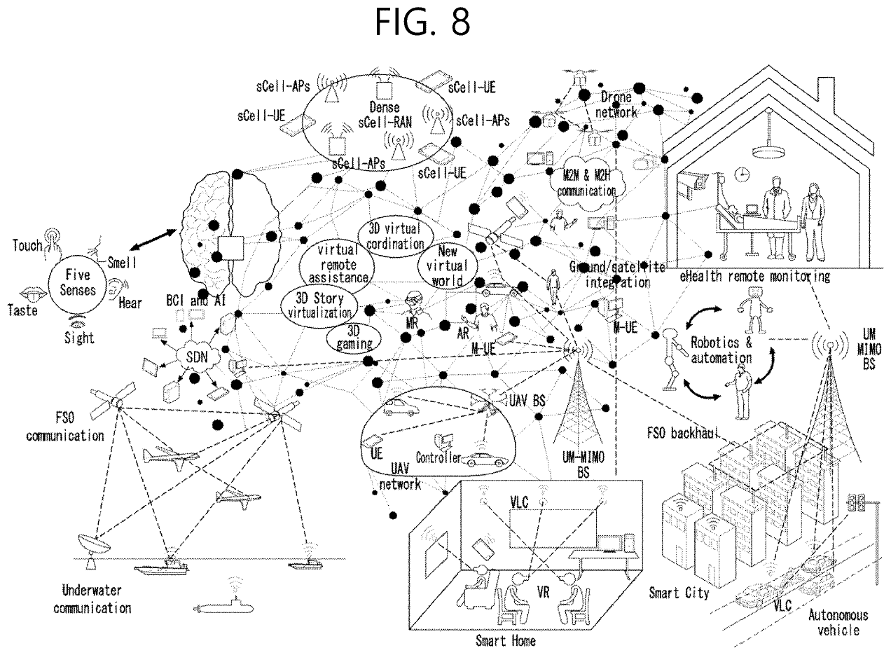

FIG. 9 shows an electromagnetic spectrum applicable to the present disclosure.

FIG. 10 shows a THz communication method applicable to the present disclosure.

FIG. 11 shows an example of a JCAS system, based on an embodiment of the present disclosure.

FIG. 12 shows an example of movement paths of communication signal and sensing signal, based on an embodiment of the present disclosure.

FIG. 13 shows an example of a MIMO-based distributed sensing concept, based on an embodiment of the present disclosure.

FIG. 14 shows an example of a JCAS sensing device, based on an embodiment of the present disclosure.

FIG. 15 shows an example of a concept of JCAS active sensing, based on an embodiment of the present disclosure.

FIG. 16 shows an example of a concept of JCAS passive sensing, based on an embodiment of the present disclosure.

FIG. 17 shows an example of signal exchanges between devices if JCAS passive sensing is performed, based on an embodiment of the present disclosure.

FIG. 18 shows an example of a JCAS sensing procedure, based on an embodiment of the present disclosure.

FIG. 19 shows an example of a JCAS passive sensing procedure, based on an embodiment of the present disclosure.

FIG. 20 shows an example of a hardware structure of a JCAS system, based on an embodiment of the present disclosure.

FIG. 21 shows an example of a JCAS distributed sensing procedure, based on an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

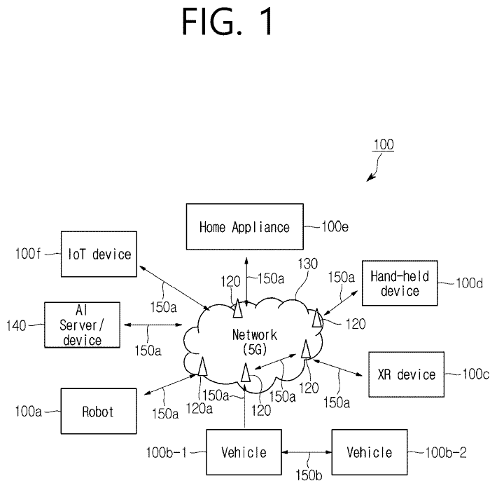

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100 a, vehicles 100 b-1 and 100 b-2, an extended reality (XR) device 100 c, a hand-held device 100 d, a home appliance 100 e, an Internet of Thing (IoT) device 100 f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100 b-1 and 100 b-2 may include an unmanned aerial vehicle (UAV) (e.g., a drone). The XR device 100 c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100 d may include a smartphone, a smart pad, a wearable device (e.g., a smart watch or smart glasses), a computer (e.g., a laptop), etc. The home appliance 100 e may include a TV, a refrigerator, a washing machine, etc. The IoT device 100 f may include a sensor, a smart meter, etc. For example, the base station 120 and the network 130 may be implemented by a wireless device, and a specific wireless device 120 a may operate as a base station/network node for another wireless device.

The wireless devices 100 a to 100 f may be connected to the network 130 through the base station 120. AI technology is applicable to the wireless devices 100 a to 100 f, and the wireless devices 100 a to 100 f may be connected to the AI server 100 g through the network 130. The network 130 may be configured using a 3G network, a 4G (e.g., LTE) network or a 5G (e.g., NR) network, etc. The wireless devices 100 a to 100 f may communicate with each other through the base station 120/the network 130 or perform direct communication (e.g., sidelink communication) without through the base station 120/the network 130. For example, the vehicles 100 b-1 and 100 b-2 may perform direct communication (e.g., vehicle to vehicle (V2V)/vehicle to everything (V2X) communication). In addition, the IoT device 100 f (e.g., a sensor) may perform direct communication with another IoT device (e.g., a sensor) or the other wireless devices 100 a to 100 f.

Wireless communications/connections 150 a, 150 b and 150 c may be established between the wireless devices 100 a to 100 f/the base station 120 and the base station 120/the base station 120. Here, wireless communication/connection may be established through various radio access technologies (e.g., 5G NR) such as uplink/downlink communication 150 a, sidelink communication 150 b (or D2D communication) or communication 150 c between base stations (e.g., relay, integrated access backhaul (IAB). The wireless device and the base station/wireless device or the base station and the base station may transmit/receive radio signals to/from each other through wireless communication/connection 150 a, 150 b and 150 c. For example, wireless communication/connection 150 a, 150 b and 150 c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

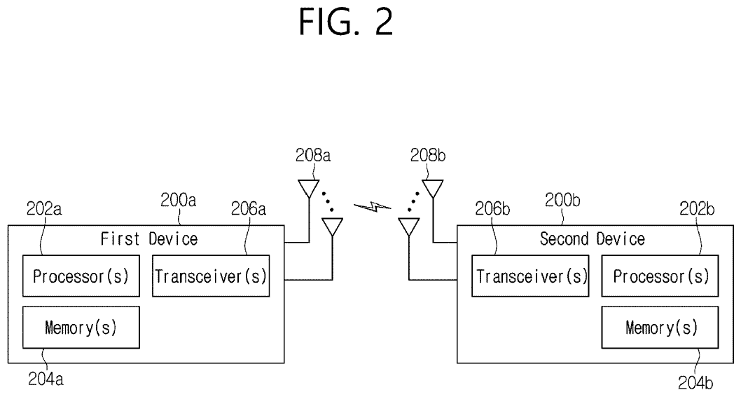

FIG. 2 shows an example of a wireless device applicable to the present disclosure.

Referring to FIG. 2, a first wireless device 200 a and a second wireless device 200 b may transmit and receive radio signals through various radio access technologies (e.g., LTE or NR). Here, (the first wireless device 200 a, the second wireless device 200 b) may correspond to (the wireless device 100 x, the base station 120) and/or (the wireless device 100 x, the wireless device 100 x) of FIG. 1.

The first wireless device 200 a may include one or more processors 202 a and one or more memories 204 a and may further include one or more transceivers 206 a and/or one or more antennas 208 a. The processor 202 a may be configured to control the memory 204 a and/or the transceiver 206 a and to implement descriptions, functions, procedures, proposals, methods and/or operational flowcharts disclosed herein. For example, the processor 202 a may process information in the memory 204 a to generate first information/signal and then transmit a radio signal including the first information/signal through the transceiver 206 a. In addition, the processor 202 a may receive a radio signal including second information/signal through the transceiver 206 a and then store information obtained from signal processing of the second information/signal in the memory 204 a. The memory 204 a may be coupled with the processor 202 a, and store a variety of information related to operation of the processor 202 a. For example, the memory 204 a may store software code including instructions for performing all or some of the processes controlled by the processor 202 a or performing the descriptions, functions, procedures, proposals, methods and/or operational flowcharts disclosed herein. Here, the processor 202 a and the memory 204 a may be part of a communication modem/circuit/chip designed to implement wireless communication technology (e.g., LTE or NR). The transceiver 206 a may be coupled with the processor 202 a to transmit and/or receive radio signals through one or more antennas 208 a. The transceiver 206 a may include a transmitter and/or a receiver. The transceiver 206 a may be used interchangeably with a radio frequency (RF) unit. In the present disclosure, the wireless device may refer to a communication modem/circuit/chip.

The second wireless device 200 b may include one or more processors 202 b and one or more memories 204 b and may further include one or more transceivers 206 b and/or one or more antennas 208 b. The processor 202 b may be configured to control the memory 204 b and/or the transceiver 206 b and to implement the descriptions, functions, procedures, proposals, methods and/or operational flowcharts disclosed herein. For example, the processor 202 b may process information in the memory 204 b to generate third information/signal and then transmit the third information/signal through the transceiver 206 b. In addition, the processor 202 b may receive a radio signal including fourth information/signal through the transceiver 206 b and then store information obtained from signal processing of the fourth information/signal in the memory 204 b. The memory 204 b may be coupled with the processor 202 b to store a variety of information related to operation of the processor 202 b. For example, the memory 204 b may store software code including instructions for performing all or some of the processes controlled by the processor 202 b or performing the descriptions, functions, procedures, proposals, methods and/or operational flowcharts disclosed herein. Herein, the processor 202 b and the memory 204 b may be part of a communication modem/circuit/chip designed to implement wireless communication technology (e.g., LTE or NR). The transceiver 206 b may be coupled with the processor 202 b to transmit and/or receive radio signals through one or more antennas 208 b. The transceiver 206 b may include a transmitter and/or a receiver. The transceiver 206 b may be used interchangeably with a radio frequency (RF) unit. In the present disclosure, the wireless device may refer to a communication modem/circuit/chip.

Hereinafter, hardware elements of the wireless devices 200 a and 200 b will be described in greater detail. Without being limited thereto, one or more protocol layers may be implemented by one or more processors 202 a and 202 b. For example, one or more processors 202 a and 202 b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202 a and 202 b may generate one or more protocol data units (PDUs) and/or one or more service data unit (SDU) according to the descriptions, functions, procedures, proposals, methods and/or operational flowcharts disclosed herein. One or more processors 202 a and 202 b may generate messages, control information, data or information according to the descriptions, functions, procedures, proposals, methods and/or operational flowcharts disclosed herein. One or more processors 202 a and 202 b may generate PDUs, SDUs, messages, control information, data or information according to the functions, procedures, proposals and/or methods disclosed herein and provide the PDUs, SDUs, messages, control information, data or information to one or more transceivers 206 a and 206 b. One or more processors 202 a and 202 b may receive signals (e.g., baseband signals) from one or more transceivers 206 a and 206 b and acquire PDUs, SDUs, messages, control information, data or information according to the descriptions, functions, procedures, proposals, methods and/or operational flowcharts disclosed herein.

One or more processors 202 a and 202 b may be referred to as controllers, microcontrollers, microprocessors or microcomputers. One or more processors 202 a and 202 b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202 a and 202 b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202 a and 202 b or stored in one or more memories 204 a and 204 b to be driven by one or more processors 202 a and 202 b. The descriptions, functions, procedures, proposals, methods and/or operational flowcharts disclosed herein implemented using firmware or software in the form of code, a command and/or a set of commands.

One or more memories 204 a and 204 b may be coupled with one or more processors 202 a and 202 b to store various types of data, signals, messages, information, programs, code, instructions and/or commands. One or more memories 204 a and 204 b may be composed of read only memories (ROMs), random access memories (RAMs), erasable programmable read only memories (EPROMs), flash memories, hard drives, registers, cache memories, computer-readable storage mediums and/or combinations thereof. One or more memories 204 a and 204 b may be located inside and/or outside one or more processors 202 a and 202 b. In addition, one or more memories 204 a and 204 b may be coupled with one or more processors 202 a and 202 b through various technologies such as wired or wireless connection.

One or more transceivers 206 a and 206 b may transmit user data, control information, radio signals/channels, etc. described in the methods and/or operational flowcharts of the present disclosure to one or more other apparatuses. One or more transceivers 206 a and 206 b may receive user data, control information, radio signals/channels, etc. described in the methods and/or operational flowcharts of the present disclosure from one or more other apparatuses. For example, one or more transceivers 206 a and 206 b may be coupled with one or more processors 202 a and 202 b to transmit/receive radio signals. For example, one or more processors 202 a and 202 b may perform control such that one or more transceivers 206 a and 206 b transmit user data, control information or radio signals to one or more other apparatuses. In addition, one or more processors 202 a and 202 b may perform control such that one or more transceivers 206 a and 206 b receive user data, control information or radio signals from one or more other apparatuses. In addition, one or more transceivers 206 a and 206 b may be coupled with one or more antennas 208 a and 208 b, and one or more transceivers 206 a and 206 b may be configured to transmit/receive user data, control information, radio signals/channels, etc. described in the descriptions, functions, procedures, proposals, methods and/or operational flowcharts disclosed herein through one or more antennas 208 a and 208 b. In the present disclosure, one or more antennas may be a plurality of physical antennas or a plurality of logical antennas (e.g., antenna ports). One or more transceivers 206 a and 206 b may convert the received radio signals/channels, etc. from RF band signals to baseband signals, in order to process the received user data, control information, radio signals/channels, etc. using one or more processors 202 a and 202 b. One or more transceivers 206 a and 206 b may convert the user data, control information, radio signals/channels processed using one or more processors 202 a and 202 b from baseband signals into RF band signals. To this end, one or more transceivers 206 a and 206 b may include (analog) oscillator and/or filters.

### Structure of Wireless Device Applicable to the Present Disclosure

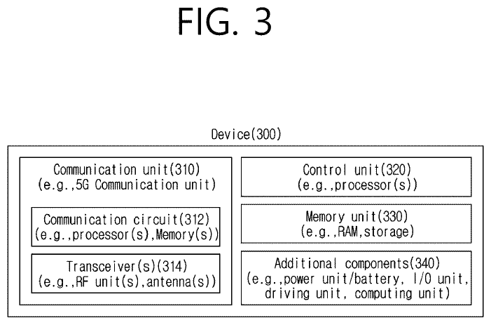

FIG. 3 shows another example of a wireless device applicable to the present disclosure.

Referring to FIG. 3, a wireless device 300 may correspond to the wireless devices 200 a and 200 b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202 a and 202 b and/or one or more memories 204 a and 204 b of FIG. 2. For example, the transceiver(s) 314 may include one or more transceivers 206 a and 206 b and/or one or more antennas 208 a and 208 b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100 a), the vehicles (FIG. 1, 100 b-1 and 100 b-2), the XR device (FIG. 1, 100 c), the hand-held device (FIG. 1, 100 d), the home appliance (FIG. 1, 100 e), the IoT device (FIG. 1, 100 f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

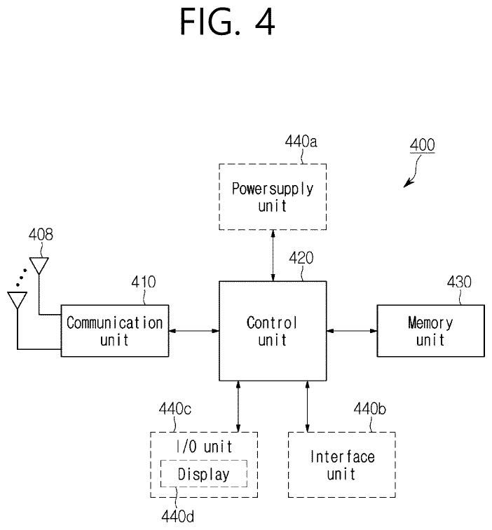

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440 a, an interface unit (interface) 440 b, and an input/output unit 440 c. An antenna unit (antenna) 408 may be part of the communication unit 410. The blocks 410 to 430/440 a to 440 c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440 a may supply power to the hand-held device 400 and include a wired/wireless charging circuit, a battery, etc. The interface unit 440 b may support connection between the hand-held device 400 and another external device. The interface unit 440 b may include various ports (e.g., an audio input/output port and a video input/output port) for connection with the external device. The input/output unit 440 c may receive or output video information/signals, audio information/signals, data and/or user input information. The input/output unit 440 c may include a camera, a microphone, a user input unit, a display 440 d, a speaker and/or a haptic module.

For example, in case of data communication, the input/output unit 440 c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440 c in various forms (e.g., text, voice, image, video and haptic).

### Type of Wireless Device Applicable to the Present Disclosure

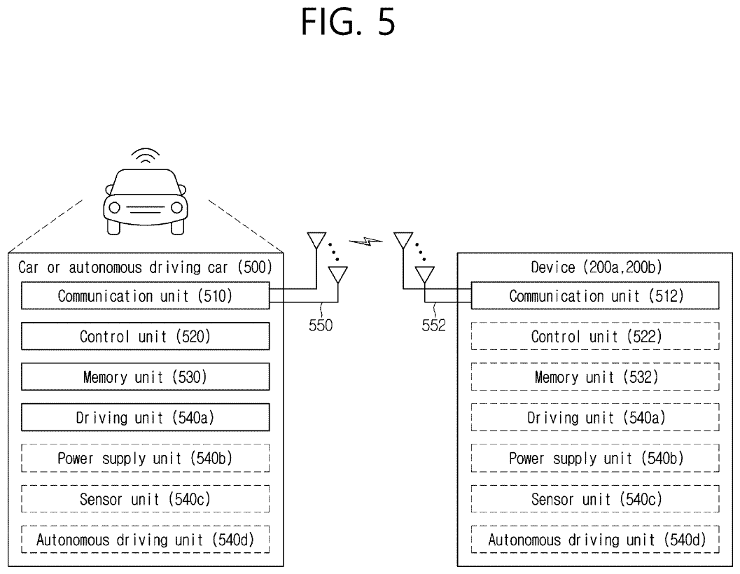

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540 a, a power supply unit (power supply) 540 b, a sensor unit 540 c, and an autonomous driving unit 540 d. The antenna unit 550 may be configured as part of the communication unit 510. The blocks 510/530/540 a to 540 d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

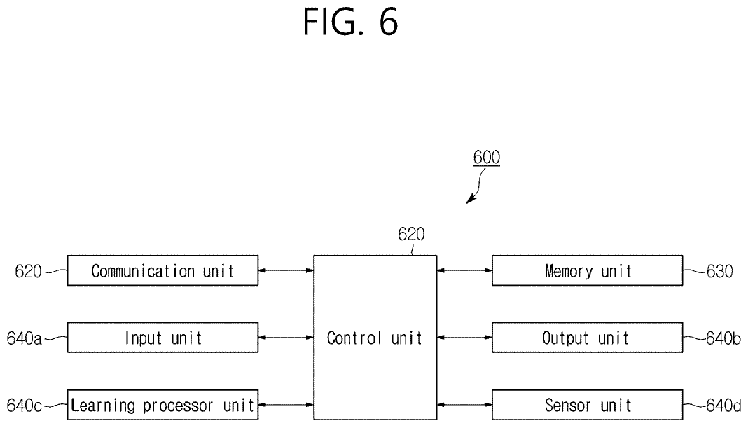

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640 a/640 b, a leaning processor unit (learning processor) 640 c and a sensor unit 640 d. The blocks 610 to 630/640 a to 640 d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100 x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640 c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640 c or transmit the history information to the AI server (FIG. 1, 140). The collected history information may be used to update a learning model.

The memory unit 630 may store data supporting various functions of the AI device 600. For example, the memory unit 630 may store data obtained from the input unit 640 a, data obtained from the communication unit 610, output data of the learning processor unit 640 c, and data obtained from the sensing unit 640. In addition, the memory unit 630 may store control information and/or software code necessary to operate/execute the control unit 620.

The input unit 640 a may acquire various types of data from the outside of the AI device 600. For example, the input unit 640 a may acquire learning data for model learning, input data, to which the learning model will be applied, etc. The input unit 640 a may include a camera, a microphone and/or a user input unit. The output unit 640 b may generate video, audio or tactile output. The output unit 640 b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640 c may train a model composed of an artificial neural network using training data. The learning processor unit 640 c may perform AI processing along with the learning processor unit of the AI server (FIG. 1, 140). The learning processor unit 640 c may process information received from an external device through the communication unit 610 and/or information stored in the memory unit 630. In addition, the output value of the learning processor unit 640 c may be transmitted to the external device through the communication unit 610 and/or stored in the memory unit 630.

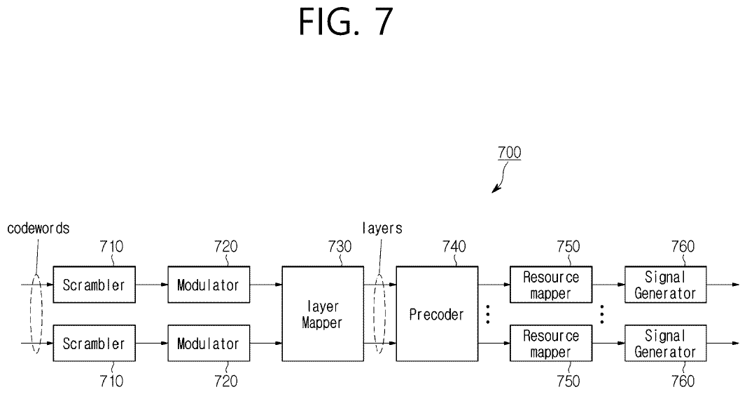

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202 a and 202 b and/or the transceiver 206 a and 206 b of FIG. 2. In addition, for example, the hardware element of FIG. 7 may be implemented in the processors 202 a and 202 b of FIG. 2 and/or the transceivers 206 a and 206 b of FIG. 2. For example, blocks 710 to 760 may be implemented in the processors 202 a and 202 b of FIG. 2. In addition, blocks 710 to 750 may be implemented in the processors 202 a and 202 b of FIG. 2 and a block 760 may be implemented in the transceivers 206 a and 206 b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200 a or 200 b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

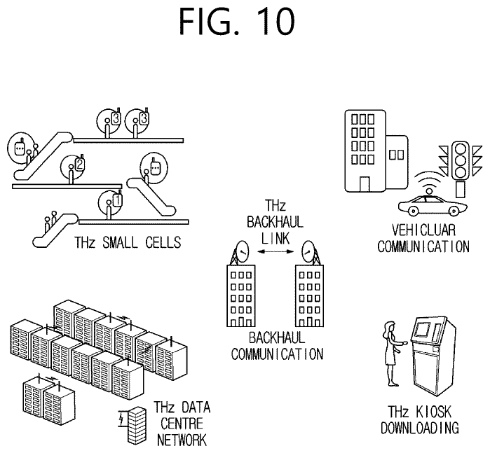

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel measurement and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

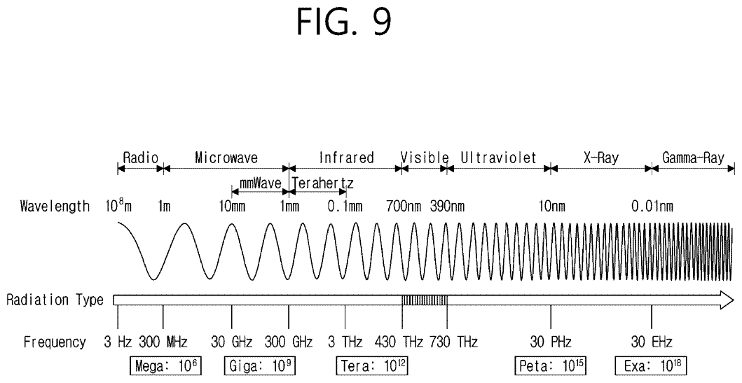

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RE.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Detailed Embodiments of the Present Disclosure

In the 6G environment, technical demands such as object recognition, positioning, and location-based services within a space are increasing in order to provide various services such as Massive IoT (Internet of Things). Therefore, as a sensing technology, Joint Communication and Sensing (JCAS), integrating communication technology and radar technology, has emerged. JCAS technology is one of the key 6G technologies for performing positioning and object sensing within a space.

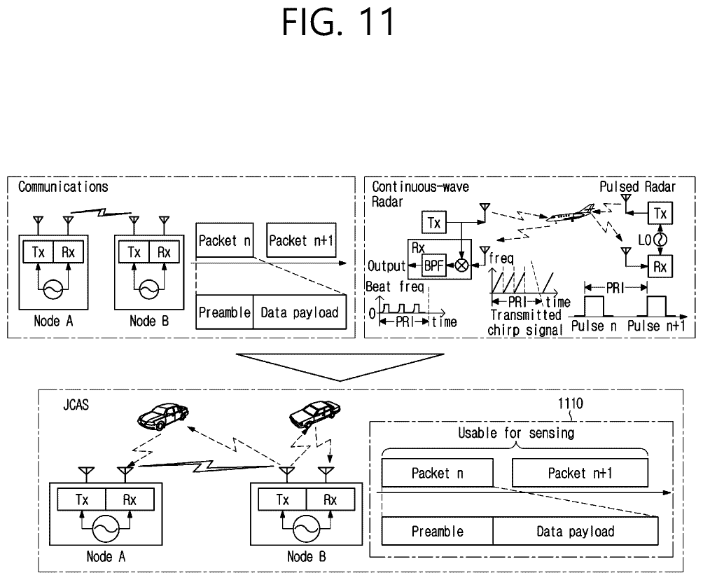

Currently, communication technology and radar technology each operate by allocating separate frequency resources. In contrast, JCAS combines radar signals with communication signals, specifically OFDM packet signals, and performs sensing by utilizing existing communication network infrastructure. Through this, the efficiency of frequency resources can be improved. Additionally, since UE and base station communications as well as radar technology can be implemented using the same hardware, hardware costs can be reduced. FIG. 11 shows an example of a JCAS system, based on an embodiment of the present disclosure. Referring to FIG. 11, a JCAS packet signal shared by communication signals and radar signals can be identified.

JCAS technology, as an ultra-precise spatial sensing technology, may be applied in various vertical environments. For example, smart city, smart factory, smart home, and vehicular network. Table 2 below illustrates use cases of smart home and vehicular network, which are detailed application examples of JCAS technology.

TABLE 2

| | Use Case | |
|---|---|---|
| No | Smart Home | Vehicular Network |
| 1 | Human presence detection | Raw data exchange and high-precision |
| | | localization |
| 2 | Human proximity detection | Secure hands-free access |
| 3 | Fall detection | Vehicle platooning |
| 4 | Sleep monitoring | Simultaneous localization and mapping |
| 5 | Daily activity recognition | Extended sensor |

Camera image sensing technology, another spatial sensing technology, has privacy issues, and wireless indoor positioning technology has limitations in performing precise sensing due to meter-level errors. In contrast, JCAS combines communication technology and radar technology, thus implementing ultra-precise positioning without privacy issues. In addition, JCAS implements both communication technology and radar technology using the same frequency resources and hardware structure, thereby improving frequency efficiency and providing cost reduction effects. The necessity of JCAS technology is described below.

First, JCAS technology provides spectrum efficiency. Because the spectrum is a scarce resource, using the same spectrum for sensing and communication is more efficient than using dedicated spectrum for each. Ideally, spectrum efficiency may be doubled by sharing spectrum to implement wireless communication and radar technologies.

Second, JCAS technology provides ultra-precise positioning services. Cellular systems are becoming ubiquitous as density increases and are used within vertical industries. Accordingly, JCAS technology enables RF sensing over wide areas through common infrastructure and spectrum reuse.

Third, JCAS technology provides the possibility of high-resolution sensing. Signal bandwidth has increased over generations, from a 20 MHz carrier in LTE to 100 MHz in sub-6 GHz 5G NR and 400 MHz in mmWave NR. New bands for 5G evolution and 6G are expected to have bandwidths greater than 1 GHz.

Fourth, JCAS technology addresses privacy issues. RF signals cause fewer privacy concerns than cameras, which may not be allowed everywhere. In addition, RF signals propagate well even in conditions difficult to detect by real-world cameras and other sensors (e.g., dusty conditions, harsh weather, or low-light environments, especially at night).

Fifth, JCAS significantly enhances wireless sensing performance through Massive MIMO deployment and spatial processing technology, which are core components of 5G.

Sixth, JCAS establishes a foundation for the required dual-function processing capability using signal processing assets including MIMO and AI/ML. This is because recent advances in artificial intelligence and machine learning for communication systems have opened the path for AI/ML to become an integral part of 5G (B5G) and beyond-6G system designs.

Seventh, JCAS reduces costs. Compared to operating two separate systems for communication and radar technology, a joint system may significantly reduce the cost and size of transceivers.

For example, object recognition technology in non-line-of-sight (NLOS) environments is increasingly required as an important technology for extending radar detection areas. High-frequency bands such as mmWave and THz, which may be used in 6G communication environments, are highly directional, thus disadvantageously affecting radar devices in recognizing objects hidden behind obstacles. For example, radar systems using the 70 GHz frequency band, commercially used for vehicles, have limitations in recognizing objects hidden behind obstacles due to the high directivity of electromagnetic waves. Because reflection and diffraction characteristics of electromagnetic waves act as vulnerabilities in NLOS environments, technologies capable of recognizing hidden objects and collecting object information are required.

To solve the problems, described above, various object recognition technologies in NLOS environments are being researched. Recently, optics-based NLOS imaging technology and time-of-flight (TOF) technology utilizing multi-bounce propagation paths have been studied. In addition, technologies to reconstruct hidden objects in NLOS environments into three-dimensional image formats using TOF technology, ultrafast lasers, and streak cameras are being studied. Moreover, optics-based NLOS imaging algorithms are being developed to improve and supplement the above hardware-based imaging technologies. In addition, infrared-based NLOS imaging methods and artificial intelligence-based algorithm development using cameras are underway.

However, the hardware-based object recognition methods described above (e.g., optics-based methods, infrared-based methods) require expensive, high-precision hardware devices. Moreover, AI-based algorithms are currently at an early development stage and require improvements in terms of accuracy and recognition speed. Table 3 below summarizes the existing technologies and their associated problems described above.

TABLE 3

| NLOS Environment Sensing | | |
|---|---|---|
| Technology | Technical Description | Problems |
| Optical Non-Line-of-Sight | TOF technology utilizing | Cost |
| Imaging | multi-bounce propagation paths | Complex streak camera setup |
| | of optical signals | |
| Non-Line-of-Sight Tracking | Camera-based AI tracking and | Limited experimental |
| and Classification | localization | scenarios of meter-scale size |
| | | Acquisition time units |
| Radio Frequency Non-Line-of- | Imaging, tracking, and pose | RF signals may not reflect if |
| Sight Imaging | estimation using RF signals | walls are made of specific |
| | | materials |
| | | Obstruction due to |
| | | incompletely connected walls |
| | | and reflective surfaces |

Considering the above, the present disclosure newly proposes a distributed sensing method using JCAS technology as an object recognition technology in NLOS environments. If vertical services expand indoors and outdoors, shaded areas depending on the space may appear variously. In particular, in V2V and V2X environments, securing technology for seeing around street corners is becoming increasingly important. Applying the distributed sensing method utilizing JCAS technology according to the present disclosure may enhance sensing performance in shaded areas within a space. According to the present disclosure, radar sensing performance (e.g., object distance, object speed, object position detection) in an NLOS environment may be improved by utilizing existing communication infrastructure (e.g., UE, base station) without dedicated hardware (e.g., optical devices, infrared devices, radar with relay walls).

Before specifically examining the proposal of the present disclosure, radar sensing technology is described below. First, related terms are defined as follows.
Uplink sensing: sensing performed using a sensing signal transmitted from a UE.
Downlink sensing: sensing performed using a sensing signal transmitted from a base station.
Downlink Active Sensing: sensing performed using an echo signal of a sensing signal directly transmitted by the base station itself (an echo signal is a sensing signal reflected by an object).
Downlink Passive Sensing: sensing performed using an echo signal of a sensing signal transmitted by a second base station rather than the first base station.

Table 4 below compares the methods and concepts of the three types of radar sensing.

TABLE 4

| KPI | Signal | Advantages | Disadvantages |
|---|---|---|---|
| Downlink Active | Receiving a reflected | Transmitter and | Must support full- |
| Sensing | downlink | receiver may exist on | duplexing |
| | communication | the same platform, | performance |
| | signal transmitted by | thus they may be | |
| | the base station itself | synchronized at | |
| | | clock-level (e.g., | |
| | | mono-static radar) | |
| Downlink Passive | Receiving a | Although the | Signal arrival time |
| Sensing | downlink | transmitter and | is delayed due to |
| | communication | receiver are spatially | signal transmission |
| | signal transmitted by | separated, their | over longer distances |
| | another base station | clocks may be | compared to |
| | | synchronized (e.g., | downlink active |
| | | bi-static radar, multi- | sensing signals |
| | | static radar) | Need to consider |
| | | | sensing algorithms |
| Uplink sensing | Receiving an uplink | The receiver | Privacy issues |
| (Active Sensing) | communication | sufficiently | Relatively lower |
| | signal transmitted | recognizes system | processing |
| | from a UE | protocols and signal | performance and |
| | transmitter | structures without | information |
| | | obtaining hardware | accessibility |
| | | and network setup | |
| | | changes | |

According to Table 4, downlink sensing may be performed by a standalone base station or multiple base stations. Downlink sensing has superior performance in terms of processing performance and information accessibility compared to uplink sensing. Thus, downlink sensing may provide more accurate sensing results than uplink sensing. Additionally, privacy issues may be resolved because sensing results obtained through downlink sensing are not directly associated with any UE.

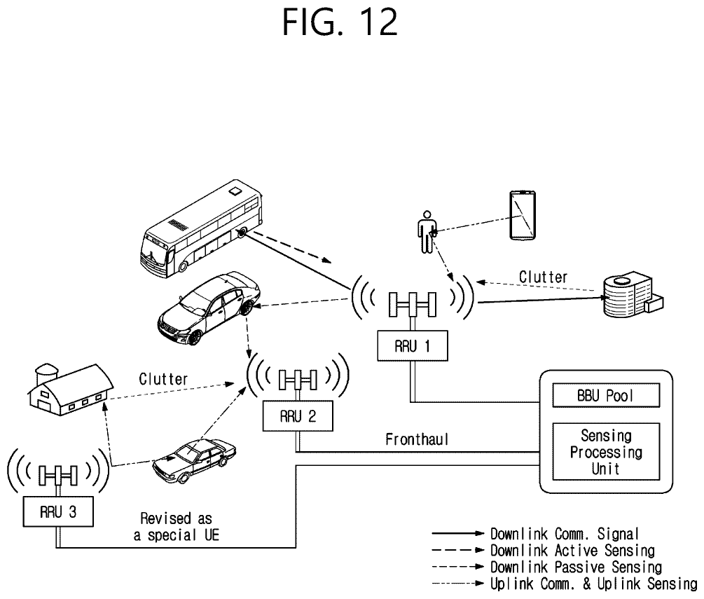

Passive sensing is a sensing method in which a device does not directly detect an object but detects it through another device. The present disclosure newly proposes a passive sensing method capable of recognizing objects in an NLOS environment. Passive sensing may be described using other terms such as distributed sensing, and it may not be limited to specific terminology. FIG. 12 shows an example of movement paths of communication signal and sensing signal, based on an embodiment of the present disclosure.

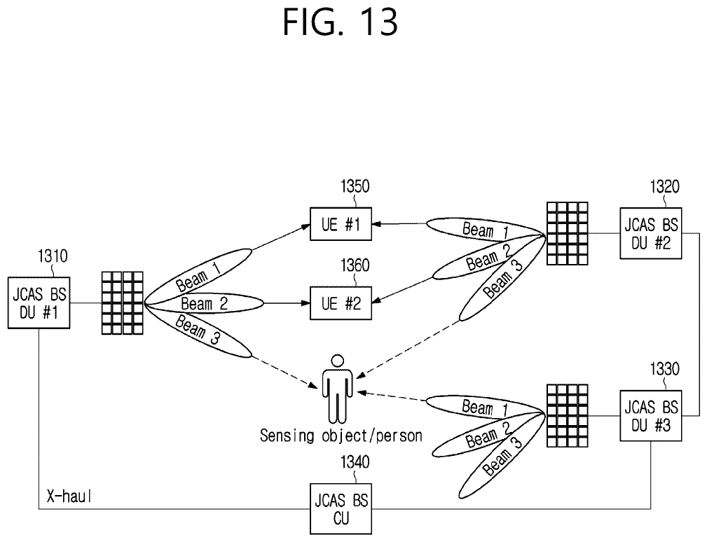

FIG. 13 shows an example of a MIMO-based distributed sensing concept, based on an embodiment of the present disclosure.

Referring to FIG. 13, it may be seen that a base station including a Central Unit, hereinafter referred to as a central base station (1340), base stations including Distributed Units, hereinafter referred to as distributed base stations (1340, 1320, 1330), and UEs (1350, 1360) perform distributed sensing. Both the central base station (1340) and the distributed base stations (1340, 1320, 1330) may perform JCAS technology. The central base station (1340) may sense objects in an NLOS environment using the distributed base stations (1340, 1320, 1330). For example, the central base station (1340) may search for distributed base stations (1340, 1320, 1330) which are in a Line-of-Sight (LOS) environment relative to an object. The central base station (1340) may request the optimal distributed base station(s) among the distributed base stations (1340, 1320, 1330) to sense the object. At least one of the distributed base stations (1340, 1320, 1330) may perform object sensing based on the distributed sensing request of the central base station (1340), and transmit sensing results to the central base station (1340) or the UEs (1350, 1360).

The MIMO-based distributed sensing technique using JCAS technology as described with reference to FIG. 13 provides the advantage of accurately recognizing objects even in an NLOS environment. Additionally, in a device performing distributed sensing using JCAS technology, sensing performance may be improved if a mobile device performing sensing functions is additionally included. For example, distributed sensing technology requires an algorithm to determine appropriate resource allocation for sensing considering multi-cell interference. Thus, the present disclosure proposes a signal exchange method for distributed sensing.

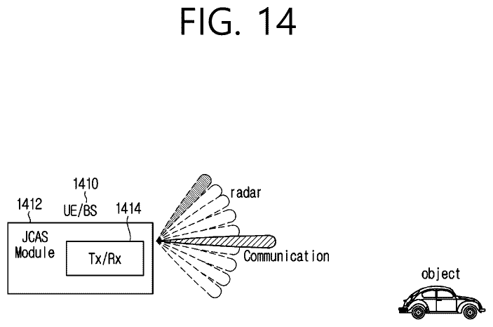

FIG. 14 shows an example of a JCAS sensing device, based on an embodiment of the present disclosure.

Referring to FIG. 14, a JCAS sensing device 1410 may include a JCAS module 1412. For example, the JCAS sensing device 1410 may be a UE or a base station. The JCAS module 1412 may include a transceiver 1414 capable of transmitting and receiving JCAS signals. Here, the JCAS signal may be a combined signal of a radar signal and a communication signal. The JCAS sensing device may detect surrounding objects using the JCAS signal. The JCAS sensing device may perform JCAS active sensing or JCAS passive sensing.

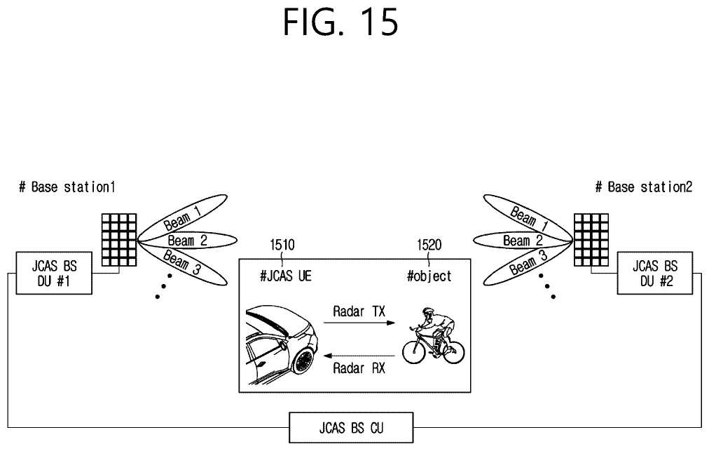

FIG. 15 shows an example of a concept of JCAS active sensing, based on an embodiment of the present disclosure. JCAS active sensing may be performed in an LOS environment.

Referring to FIG. 15, it may be seen that there is no obstacle between the UE 1510 and the object 1520, so the UE 1510 may directly sense (e.g., active sensing) the object 1520. Here, the UE 1510 may be a JCAS UE in which a communication module and a radar module are combined. The UE 1510 may transmit a sensing signal for detecting the object 1520 by using a radar transmission function. The UE 1510 may receive an echo signal reflected by the object 1520 through a radar receiving function. Subsequently, the UE 1510 may calculate information related to the object 1520 (e.g., location, speed, angle) by analyzing the echo signal.

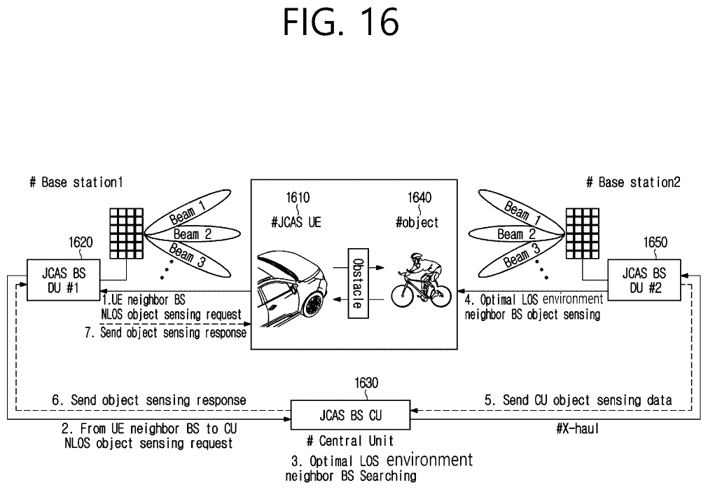

FIG. 16 shows an example of a concept of JCAS passive sensing, based on an embodiment of the present disclosure. JCAS passive sensing may be performed in an NLOS environment.

Referring to FIG. 16, it may be seen that there is an obstacle between UE 1610 and object 1640, so the UE 1610 may not directly sense (e.g., active sensing) the object 1640. Here, the UE 1610 may be a JCAS UE including a communication module and a radar module. For example, if the UE 1610 determines that it is unable to perform active sensing on a specific object, it may perform passive sensing for that object. The UE 1610 may request sensing of an object located in an NLOS environment from the nearest first base station 1620. The first base station 1620 may include a distributed unit. Subsequently, the first base station 1620 may request sensing of an object located in an NLOS environment from a second base station 1630 including a central unit. For example, FIG. 16 shows a scenario in which distributed units and central units are located at separate base stations, but this is merely an example for convenience of description and is not limited thereto. For example, a single base station may perform both distributed unit and central unit functions, or multiple base stations may respectively perform distributed unit and central unit functions.

The second base station 1630 may search for an optimal base station 1650 capable of sensing an object in an LOS environment based on the sensing request. The optimal base station 1650 may transmit a signal for sensing the object through a radar transmission (Radar TX) function. Subsequently, the optimal base station 1650 may receive an echo signal reflected by the object. The optimal base station 1650 may calculate information related to the object (e.g., location, speed, angle information) by analyzing the echo signal. The calculated object information may be transmitted to the first base station 1620 via the second base station 1630. Finally, the object information may be transmitted to the UE 1610 through the first base station 1620.

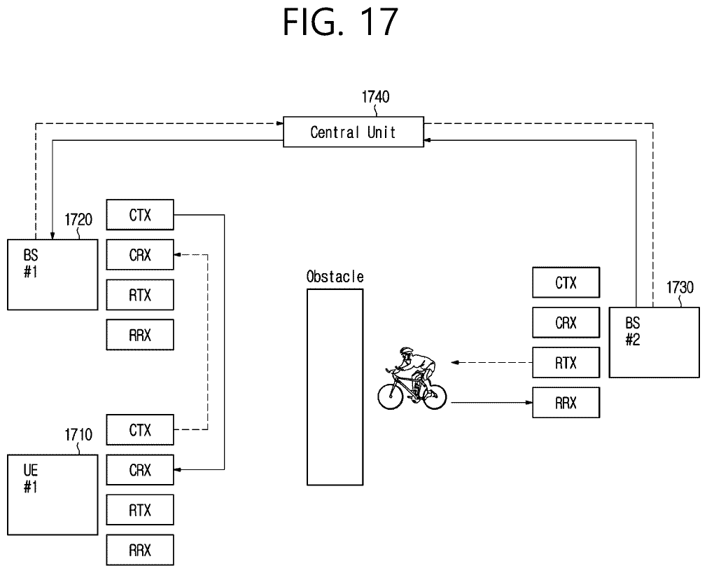

FIG. 17 shows an example of signal exchanges between devices if JCAS passive sensing is performed, based on an embodiment of the present disclosure.

Referring to FIG. 17, a UE 1710, a first base station 1720, a second base station 1730, and a central unit 1740 located in an NLOS environment due to an obstacle may be seen. The UE 1710, first base station 1720, second base station 1730, and central unit 1740 may each include a communication transmitter (CTX), communication receiver, radar transmitter (RTX), and radar receiver. For example, the communication transmitter, communication receiver, radar transmitter, and radar receiver may be included in a JCAS module combining a communication module and radar module.

Referring to FIG. 17, the dotted line represents a signal flow showing the process of performing object sensing in an LOS environment by using an optimal base station (e.g., second base station 1730) capable of active sensing on the object via nearby base stations (e.g., first base station 1720) and a central unit (e.g., central unit 1740) adjacent to the UE (e.g., vehicle) 1710. The solid line represents a signal flow showing the process in which the optimal base station (e.g., second base station 1730) transmits the sensing results of the object to the UE 1710 via the central unit 1740 and the adjacent base station (e.g., first base station 1720). In the passive sensing process of FIG. 17, the UE 1710, base station 1720, central unit 1740, and second base station 1730 may use their respective communication transmitters and communication receivers for signal exchange to perform passive sensing. The second base station 1730 may use radar transmitters and radar receivers to perform object sensing. The central unit 1740 may be located at an independent device (e.g., a base station) from the first base station 1720 and second base station 1730, or it may be located within the first base station 1720 and second base station 1730.

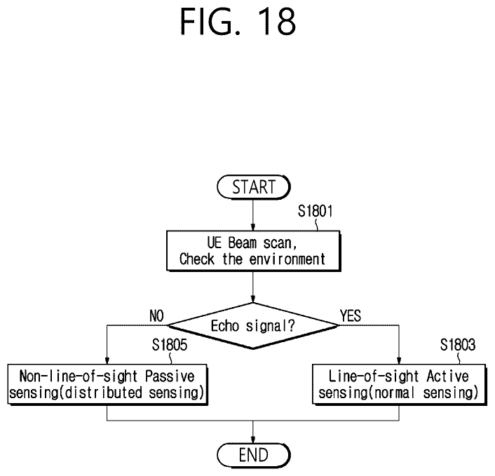

FIG. 18 shows an example of a JCAS sensing procedure, based on an embodiment of the present disclosure. The device in FIG. 18 may be a JCAS device (e.g., device 1740 of FIG. 14) including a module combining communication technology and radar technology. It is assumed that the device has previously collected information related to the surrounding environment (e.g., location information related to buildings, roadside trees, and fire hydrants).

Referring to FIG. 18, in step S1801, the device may scan the surrounding environment. For example, the device may scan surrounding objects using beam scanning (e.g., JCAS signal). At this time, the device may check whether an echo signal is received. The echo signal may be a reflected signal from an object of a JCAS signal (e.g., JCAS beam) transmitted from the device. For example, the device may not classify signals reflected by previously recognized objects as echo signals based on the previously collected information related to the surrounding environment. Thus, the device may classify signals reflected by previously unrecognized objects as echo signals.

In step S1803, if the device receives an echo signal, it may perform active sensing. For example, if the echo signal is received during a predetermined period, the device may determine it to be an LOS environment and determine object information based on the echo signal. The period for receiving the echo signal may be predetermined by user configuration or dynamically determined based on information related to the surrounding environment.

In step S1805, if the device does not receive an echo signal during the predetermined period, it may determine it as an NLOS environment and perform passive sensing (e.g., distributed sensing). For example, if the echo signal from an object previously recognized through active sensing is not detected, the device may determine that the object is in an NLOS environment due to an obstacle and perform passive sensing.

The procedure of FIG. 18 may be a JCAS sensing procedure for one object. When multiple objects need to be sensed, the device may perform sensing using multiple JCAS beams. Therefore, active sensing and passive sensing may be performed per beam.

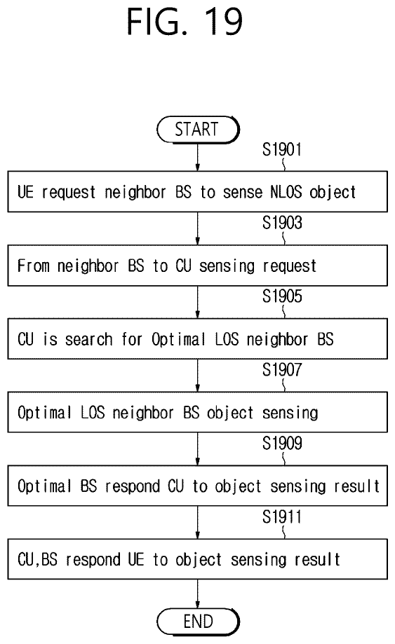

FIG. 19 shows an example of a JCAS passive sensing procedure, based on an embodiment of the present disclosure. The devices in FIG. 19 may be JCAS devices (e.g., device 1740 in FIG. 14) including modules combining communication and radar technologies. The procedure of FIG. 19 may be an example of step S1805 of FIG. 18. It is assumed that the device has previously collected information related to the surrounding environment (e.g., location information related to buildings, roadside trees, and fire hydrants).

In step S1901, the UE may transmit a distributed sensing request signal to the nearest base station (hereinafter, “nearest base station”) to sense an NLOS object. Here, the nearest base station may be the base station to which the UE is already connected, and it may be described using other terms such as a neighbor base station. The distributed sensing request signal may be transmitted through the JCAS module of the device. For example, the UE may perform distributed sensing if reception of the echo signal is interrupted during active sensing. In this case, the UE may transmit the time at which the echo signal was interrupted and location information at which the last echo signal was received to the nearest base station, along with the distributed sensing request signal.

In step S1903, the nearest base station may transmit the distributed sensing request signal to a central unit. For example, the distributed sensing request signal transmitted from the nearest base station may be the distributed sensing request signal received from the UE in step S1901. According to an example, the nearest base station may transmit a new distributed sensing request signal to the central unit based on the distributed sensing request signal received from the UE in step S1901. The nearest base station may transmit the time at which the echo signal was interrupted and location information at which the last echo signal was received, along with the distributed sensing request signal to the central unit. The central unit may be located in the nearest base station or other base stations.

In step S1905, the central unit may search for an optimal base station capable of sensing the NLOS object in an LOS environment. For example, the optimal base station may be a base station capable of directly detecting the object in an LOS environment, while the object is in an NLOS environment relative to the UE due to an obstacle. For example, the central unit may select the optimal base station by identifying whether base stations close to the UE are capable of sensing the object in an LOS environment, in order of proximity to the UE. Specifically, the central unit may request base stations, in order of proximity to the UE, to transmit a JCAS signal and confirm whether an echo signal reflected by the object is received. Here, the central unit may transmit the time at which the echo signal was interrupted and location information at which the last echo signal was received to the base stations. The base stations may determine the direction in which the JCAS signal (e.g., JCAS beam) should be transmitted for sensing the object, based on the received time information and location information. The base station receiving the echo signal may transmit a signal notifying reception of the echo signal to the central unit. The central unit may select the base station that received the echo signal as the optimal base station. When the optimal base station is selected, the central unit may request active sensing from the optimal base station.

In step S1909, the optimal base station may perform object sensing. The optimal base station may perform object sensing (e.g., active sensing) in an LOS environment. For example, the optimal base station may perform JCAS active sensing by receiving an echo signal reflected by the object from the transmitted JCAS signal. The optimal base station may determine sensing information related to the object (e.g., location information, speed information, angle information of the object) based on the echo signal.

In step S1911, the optimal base station may transmit the sensing information related to the object to the central unit. The central unit may transmit the sensing information related to the object to the UE through communication with the nearest base station.

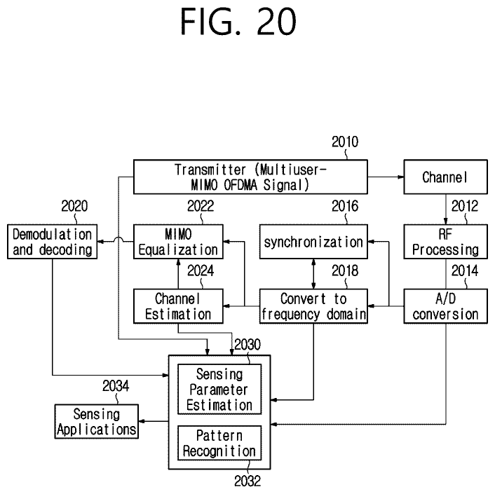

FIG. 20 shows an example of a hardware structure of a JCAS system, based on an embodiment of the present disclosure.

Referring to FIG. 20, the hardware of a JCAS system may include modules commonly used for both communication and radar technologies, modules used only for communication technology, and modules used only for radar technology.

Modules commonly used for communication and radar technologies may include a MIMO Orthogonal Frequency Division Multiple Access (OFDMA) signal transmitter (2010), an RF processing module (2012), an AD conversion module (2014), a synchronization module (2016), and a frequency conversion processing unit (2018). Modules used only for communication technology may include a modulation and decoding module (2020), a MIMO equalization module (2022), and a channel estimator (2024). Modules used only for radar technology may include a sensing parameter estimation module (2030), a pattern recognition module (2032), and sensing applications (2034). The sensing parameter estimation module (2030) may measure sensing parameters related to position and speed, such as time delay, angle-of-arrival (AoA), angle-of-departure (AoD), doppler frequency, and magnitude of multipath signals. The pattern recognition module (2032) may perform application-oriented object, motion, and event recognition and classification by combining machine learning and signal processing technologies using wireless signals. Sensing applications (2034) may support smart transportation, smart cities, smart homes, industrial IoT, environmental sensing, and sensing-aided communication. The hardware structure illustrated in FIG. 20 is merely an example provided for convenience of description, and thus it is not limited thereto, and the described modules may be omitted or additional modules may be added.

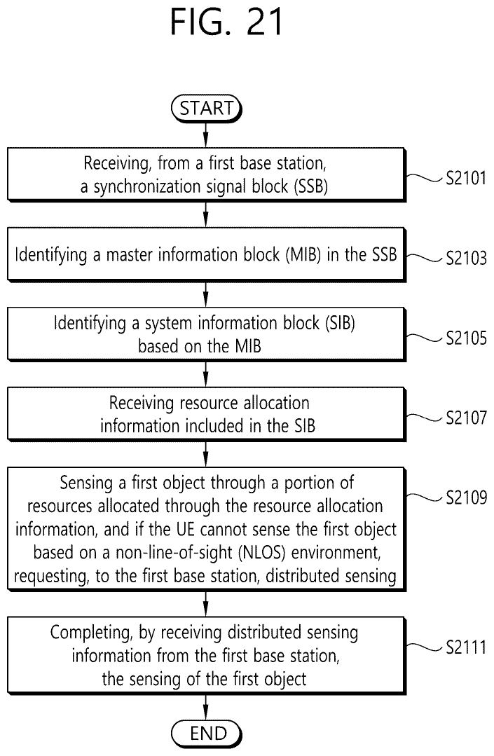

FIG. 21 shows an example of a JCAS distributed sensing procedure, based on an embodiment of the present disclosure.

Referring to FIG. 21, in step S2101, the device may receive a synchronization signal block (SSB) from a first base station. In step S2103, the device may obtain a master information block (MIB) in the SSB. In step S2105, the device may obtain a system information block (SIB) based on the MIB. In step S2107, the device may receive resource allocation information included in the SIB.

In step S2109, based on the resource allocation information, the device may request distributed sensing (e.g., passive sensing) from the first base station. The first base station may request distributed sensing from the central unit based on the distributed sensing request of the device. The central unit may search for a second base station capable of performing active sensing on the object to be sensed, based on the distributed sensing request.

In step S2111, the device may receive distributed sensing information from the first base station. The distributed sensing information may include results obtained from active sensing performed by the second base station on the object in an LOS environment. For example, the distributed sensing information may include object location information and distance information determined based on an echo signal reflected by the object from a JCAS signal transmitted by the second base station. The device may receive the distributed sensing information determined by the second base station through the central unit and the first base station.

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method for operating a user equipment (UE) the method comprising:
receiving, from a first base station, a synchronization signal block (SSB);
identifying a master information block (MIB) based on the SSB;
identifying a system information block (SIB) based on the MIB;
receiving resource allocation information included in the SIB;
sensing a first object through a portion of resources allocated through the resource allocation information, and based on that the UE cannot sense the first object based on a non-line-of-sight (NLOS) environment, requesting, to the first base station, distributed sensing; and
completing, by receiving distributed sensing information from the first base station, the sensing of the first object.

2. The method of claim 1,
wherein the requesting of the distributed sensing is transmitted to a second base station by a central unit, and
wherein the distributed sensing information is a sensing result performed by the second base station in a line-of-sight (LOS) environment.

3. The method of claim 2,
wherein the sensing performed in the LOS environment is sensing for the first object, which is in an NLOS environment for the UE and in a LOS environment for the second base station.

4. The method of claim 1,
wherein the distributed sensing is not performed based on that the UE receives an echo signal, and is performed based on that the UE does not receive the echo signal, and
wherein the echo signal is a signal reflected by an object to be sensed from a JCAS signal transmitted by the UE.

5. The method of claim 4,
wherein the UE has information related to a surrounding environment excluding the object to be sensed.

6. The method of claim 2,
wherein the second base station is determined by the central unit by identifying whether multiple base stations, in order of proximity to the UE, are in a LOS environment for the first object.

7. The method of claim 6,
wherein whether to be in the LOS environment is determined based on whether an echo signal, reflected from the first object by a joint communication and sensing (JCAS) signal transmitted from at least one of the multiple base stations based on a request from the UE, is received by the at least one of the multiple base stations.

8. The method of claim 2,
wherein at least one of the UE, the first base station, and the second base station includes a JCAS module capable of simultaneously implementing radar technology and communication technology.

9. The method of claim 1,
wherein the distributed sensing is performed by using a JCAS signal.

10. A method for operating a first base station in a wireless communication system, the method comprising:
transmitting, to a UE, a synchronization signal block (SSB);
receiving a distributed sensing request from the UE based on that the UE performs sensing of a first object using a portion of resources allocated through resource allocation information based on the SSB and cannot sense the first object based on a non-line-of-sight (NLOS) environment; and
transmitting, to the UE, distributed sensing information.

11. A UE comprising:
a transceiver; and
a processor coupled with the transceiver,
wherein the processor is configured to perform operations comprising:
receiving, from a first base station, a synchronization signal block (SSB);
identifying a master information block (MIB) based on the SSB;
identifying a system information block (SIB) based on the MIB;
receiving resource allocation information included in the SIB;
sensing a first object through a portion of resources allocated through the resource allocation information, and based on that the UE cannot sense the first object based on a non-line-of-sight (NLOS) environment, requesting, to the first base station, distributed sensing; and
completing, by receiving distributed sensing information from the first base station, the sensing of the first object.

12-14. (canceled)

15. The first base station of claim 10,
wherein the request of the distributed sensing is transmitted to a second base station by a central unit, and
wherein the distributed sensing information is a sensing result performed by the second base station in a line-of-sight (LOS) environment.

16. The UE of claim 11,
wherein the requesting of the distributed sensing is transmitted to a second base station by a central unit, and
wherein the distributed sensing information is a sensing result performed by the second base station in a line-of-sight (LOS) environment.

17. The UE of claim 15,
wherein the sensing performed in the LOS environment is sensing for the first object, which is in an NLOS environment for the UE and in a LOS environment for the second base station.

18. The UE of claim 11,
wherein the distributed sensing is not performed based on that the UE receives an echo signal, and is performed based on that the UE does not receive the echo signal, and
wherein the echo signal is a signal reflected by an object to be sensed from a JCAS signal transmitted by the UE.

19. The UE of claim 17,
wherein the UE has information related to a surrounding environment excluding the object to be sensed.

20. The UE of claim 16,
wherein the second base station is determined by the central unit by checking whether multiple base stations, in order of proximity to the UE, are in a LOS environment for the first object.

21. The UE of claim 19,
wherein whether to be in the LOS environment is determined based on whether an echo, reflected from the first object by a joint communication and sensing (JCAS) signal transmitted from at least one of the multiple base stations, is received by the at least one of the multiple base stations based on a request from the UE.

22. The UE of claim 11,
wherein at least one of the UE, the first base station, and a second base station includes a JCAS module capable of simultaneously implementing radar technology and communication technology.

23. The UE of claim 11,
wherein the distributed sensing is performed by using a JCAS signal.
